(19) United States
(12) Patent Application Publication
(10) Pub. No.: US 2007/0217987 A1
(43) Pub. Date: Sep. 20, 2007

(54) METHOD AND APPARATUS FOR OZONE GENERATION

(75) Inventors: Raymond Belanger, Chilliwack (CA); Robert Triebe, Carlsbad Springs (CA); Tim Angus, Nepean (CA); Oliver Toffoli, Ottawa (CA)

Correspondence Address: AKERMAN SENTERFITT, P.O. BOX 3188, WEST PALM BEACH, FL, 33402-3188, US

(73) Assignee: THERMAL ENERGY INTERNATIONAL INC., Nepean (CA)

(21) Appl. No.: 11/686,701

(22) Filed: Mar. 15, 2007

Related U.S. Application Data
(60) Provisional application No. 60/783,037, filed on Mar. 17, 2006.

(51) Int. Cl. C01B 25/00; C01B 15/00; C01B 13/10

(52) U.S. Cl. 423/299; 423/581

(57) ABSTRACT

This invention describes a stand-alone ozone generator and method to generate high quantities of ozone which can be injected in a multitude of applications where great quantities are needed at a low production cost. This generator can be useful for flue gas oxidation, water purification, HVAC air purification, and any other commercial or industrial process where ozone is needed to oxidize organic or inorganic species. The process relies on the reaction of air or oxygen with a solution of white or yellow phosphorus contained in a reactor. In this method, the ozone generated is purified in-Situ and can be directly used in any process. The elemental phosphorus and the phosphorus derivatives are enclosed in the ozone generator and are not allowed to escape. The process can pay for itself by the sales of the phosphorus derivatives generated through the reaction.

### CROSS REFERENCE TO RELATED APPLICATIONS

This application claims the benefit of U.S. Provisional Application No. 60,783,037, filed Mar. 17, 2006, which is incorporated herein by reference.

### FIELD OF THE INVENTION

The present invention relates to ozone generation processes and ozone generators, in particular phosphorus-based ozone generation.

### BACKGROUND OF THE INVENTION

Ozone is one of the strongest oxidizing agents found in nature. Ozone protects the earth from the sun's harmful ultraviolet rays. It is also an ingredient of the infamous chemical smog found in cities at rush hour. Ozone has been found to be useful as a disinfectant. The antiseptic properties of ozone are useful for water and air purification, room sanitation, equipment sterilization, and food preservation. Ozone is considered a better alternative to chlorine-based sanitation or bleaching processes. Ozone has been found of great importance for certain industrial chemical reactions in flue gas treatment for harmful pollutants abatement.

Ozone is an allotropic form of oxygen and is unstable having a half-life of about 22 minutes at room temperature. Ozone must thus be generated on-site for its many industrial, commercial and household uses.

There are several methods of generating ozone. The most commonly used are ultraviolet radiation and corona discharge. Ultraviolet lamps have been used for decades to generate ozone. A mercury lamp is usually used which emits UV light at 185 and 254 nanometers (nm). The radiation at 185 nm disassociates diatomic oxygen into atomic oxygen, each atom of which then combines with a molecule of diatomic oxygen to form an ozone molecule (O₃). However, the radiation at 254 nm tends to break down the ozone molecule, which then reverts back to diatomic oxygen. The efficiency of such a system is somewhat low, the quantity of ozone produced being usually only a few grams per hour per lamp.

The technologies involved in corona discharge ozone generation are varied, but all operate fundamentally by passing dried, oxygen-containing gas through an electrical field generated using a dielectric. The electrical current causes the “split” in the oxygen molecules as described above in relation to the ultraviolet lamp. The corona technologies are usually of two types, continuous or modulated current. Since at least 85% or more of the electrical energy supplied to a corona discharge ozone generator is converted into heat, water or air cooling is required. Moreover, the gas feeding the ozone generator must be very dry (minimum dew point of −80 deg. F.), because the presence of moisture affects ozone production and leads to the formation of nitric acid. Nitric acid is very corrosive to critical internal parts of a corona discharge ozone generator, can cause premature failure and will significantly increase the frequency of maintenance. The quantity of ozone generated is greater than that with ultraviolet radiation and can reach up to 10 kg per hour on some modular systems using dry and pure oxygen. However, such systems can be quite expensive to acquire, operate and maintain while occupying significant real estate. They also need bulk or on-site generated oxygen to reach high ozone output, but are somewhat reliable.

A third approach for ozone production is through a chemical reaction route using phosphorus, which reacts with oxygen to produce ozone. Chang et al. (U.S. Pat. No. 5,164,167, U.S. Pat. No. 5,106,601, U.S. Pat. No. 5,348,715) disclosed the use of a suspension or emulsion of liquid white phosphorus in water (two immiscible chemicals) in a scrubbing tower to oxidize nitric oxide to nitrogen dioxide. The phosphorus was used to chemically produce ozone which then reacted with the nitrous oxide. In another patent (U.S. Pat. No. 5,332,563) Chang discloses the use of a phosphorus suspension to generate ozone by bubbling air through the suspension. The limitations of that approach lie in the use of a water emulsion or suspension of white phosphorus, both or which require sophisticated equipment to generate and maintain.

In order to create ozone with phosphorous, oxygen molecules (from pure O2 or air) need to react with either solid or liquid phosphorus or with phosphorus vapors. Liquid phosphorus burns very quickly in contact with air, usually generating a large amount of excess heat, which heat leads to a rapid decomposition of any ozone generated in the reaction. Aqueous emulsions or suspensions of liquid phosphorus are employed in the prior art processes to control or slow down the reaction rate. In such an emulsion or suspension, small droplets of liquid phosphorus are individually surrounded by a water jacket. However, such emulsions or suspensions limit the phosphorus/oxygen reaction rate too much, since the transfer rate of phosphorus vapor across the protective water jacket is very low. Moreover, once the water jacket is evaporated the phosphorus droplet is completely exposed and burns almost instantly, creating excess heat which causes rapid decomposition of any ozone produced. Thus, the challenge with these prior art processes is to produce phosphorus vapor at a controllable rate and at a concentration which will not lead to self-combustion of the liquid phosphorus, while at the same time achieving a sufficiently high ozone generation rate.

### SUMMARY OF THE INVENTION

It is now an object of the invention to provide a method for producing phosphorus vapors at a controllable rate.

The present invention provides a method for producing phosphorus vapor under controlled conditions and at a controllable rate. This is achieved by producing a phosphorus solution by dissolving yellow or white phosphorus in an organic or inorganic solvent and controlling the rate of release of the phosphorus vapor from the solution. The rate of phosphorus vapor release is preferably controlled by controlling the rate of evaporation of the solvent. Any solvents in which phosphorus is at least partially soluble can be used. Preferred solvents are those in which phosphorous is fully soluble. By using a solvent as a carrier medium for the phosphorous, it is possible to generate phosphorus vapors above the solution, at a controllable rate. The amount of phosphorus vapor released from the solution at any given time depends on the vapor pressure of the dissolved phosphorus. Of course, the vapor pressure of the dissolved phosphorus is dependent on the solvent used, the phosphorus to solvent ratio, the ambient pressure, the temperature of the solvent, the ambient temperature, etc.

Preferred solvents useful for operation of the present invention include, but are not limited to, ethanol, ether, chloroform, hexane, benzene, carbon disulfide, olive oil, oil of turpentine, oil of cloves, oil of mace, oil of aniseed, etc, or any other solvents in which elemental phosphorus dissolves.

It is another object of the present invention to provide a method and apparatus for ozone generation, which overcomes at least one of the problems of the known art.

It is a further object of the invention to provide a more efficient ozone generation process.

It is another object of this invention to provide an ozone generator that has an elevated ozone output.

In a preferred aspect, the invention provides an ozone generator including a reaction chamber, a phosphorous solution supply, a supply of a source gas containing oxygen, and means for contacting the phosphorus solution with the source gas to produce ozone by reaction of the oxygen with phosphorus vapor present at a source gas/phosphorus solution interface.

In a preferred embodiment of the ozone generator, the means for contacting is a reaction chamber, the phosphorus solution supply is a container located in the reaction chamber and holding the phosphorus solution and the source gas supply is a conduit entering the reaction chamber for directing the source gas onto the phosphorus solution in the container.

In a further preferred embodiment of the ozone generator, the means for contacting is a reaction chamber, the source gas supply is a flue gas conduit connected to the reaction chamber for directing an oxygen containing flue gas stream into the chamber, and the phosphorus solution supply is a spray arrangement for spraying the phosphorus solution into the flue gas stream in the reaction chamber.

In yet another preferred embodiment of the ozone generator, the phosphorus solution supply is a container at least partially filled with the phosphorus solution and the means for contacting is a bubbler arrangement for bubbling the source gas through the phosphorus solution.

In still another preferred aspect, the invention provides a standalone ozone generator, which can be utilized in all applications where ozone is needed to oxidize organic or inorganic molecules.

In yet a further preferred aspect, the present invention provides an ozone generation process, wherein ozone is generated with increased efficiency by obtaining a phosphorus solution including yellow or white phosphorus dissolved in an organic or inorganic solvent and exposing the solution to oxygen.

In a further aspect, the invention provides a process for obtaining a clean ozone stream substantially free of any contaminants other than oxygen and nitrogen.

In yet another aspect, the invention provides a means for producing usable by-products of the ozone generation process that can either be directly utilized in another process or sold.

The ozone produced with an apparatus or method in accordance with this invention is preferably used to oxidize organic and inorganic molecules or elements contained in a solid, liquid, or gas form, or in a heterogeneous mixture.

Regardless which solvent is used, it is one object of the ozone generation method to bring phosphorus vapor in contact with oxygen. When oxygen as is brought into contact with the phosphorus solution, ozone is generated by reaction of the phosphorus vapor present at the solution/gas interface with the oxygen. Ozone is generated in greater concentration than with the use of a phosphorous suspension or emulsion wherein globules of phosphorus are stirred into water. The oxygen is preferably in the form of an oxygen containing gas, whereby the oxygen containing gas can be pure oxygen, air, or any other gas containing oxygen in the gaseous phase.

The ozone generation method according to this invention preferably further includes the step of purifying the ozone generated. The solvent and the products of the reaction are preferably separated from the stream of ozone leaving the reactor. It is also preferred that the formation of the byproducts does not interfere with the generation of ozone or the performance of the reactor.

The ozone and any derivative reactive species or byproducts produced from the aforementioned methods can be directed to any such process where ozone molecules and its radicals are needed. Alternatively, the ozone generation process of the invention can be employed in situ at the location where the generated ozone is to be used.

### BRIEF DESCRIPTION OF THE DRAWINGS

The invention will now be further described by way of example only and with reference to the attached drawings, wherein

FIG. 1 is a schematic diagram of a preferred ozone generation process in accordance with the invention;

FIG. 2 is a schematic diagram of a variant of the ozone generation process of FIG. 1;

FIG. 3 is schematic diagram of a preferred embodiment of an ozone generator in accordance with the invention;

FIG. 4 is a schematic diagram of a modified ozone generator as shown in FIG. 3;

FIG. 5 is a schematic diagram of a preferred ozone generation process in accordance with the invention for the reaction of the generated ozone directly with other chemical species;

FIG. 6 is a schematic diagram of another exemplary ozone generation process in accordance with the invention wherein the source gas is bubbled through a phosphorus solution;

FIG. 7 is a schematic diagram of another exemplary process in accordance with the invention wherein the ozone gas is used for treatment of a liquid;

FIG. 8 is a schematic diagram of another exemplary ozone generation process in accordance with the invention wherein a liquid to be treated and the phosphorus solution are simultaneously sprayed into a reaction tower;

FIG. 9 is a schematic diagram of another exemplary ozone generation process in accordance with the invention wherein the ozone produced is used directly to treat solid waste;

FIG. 10 is a variation of the process shown in FIG. 9, wherein the solid to be treated is fluidized; and

FIG. 11 is a graph illustrating the NO conversion rate achieved with an exemplary embodiment of the process schematically shown in FIG. 5.

### DETAILED DESCRIPTION OF PREFERRED EMBODIMENTS

The present invention will be described more fully hereinafter with reference to preferred embodiments of the invention. This invention may be embodied in many different forms, however, and should not be construed as limited to the embodiments set forth within. Applicants provide these embodiments so that this disclosure will be thorough and complete, and willfully convey the scope of the invention to those skilled in the art.

The most general aspect of the invention is directed to the generation of phosphorus vapor at a controlled rate. That is achieved by dissolving phosphorus in a solvent and controlling the vapor pressure of the dissolved phosphorus. By controlling the vapor pressure of the dissolved phosphorus, one can directly control the rate at which phosphorus vapor is released from the solvent. The rate at which phosphorus vapor is released from the solvent is preferably controlled by controlling the rate of evaporation of the solvent. The vapor pressure of the dissolved phosphorus is generally dependent on the solvent, the phosphorus to solvent ratio, the ambient pressure, the temperature of the solvent and the ambient pressure. Phosphorus vapors may be achieved in some cases even at relatively low temperatures. The local average concentration of phosphorus is much greater in a solution than in a suspension or emulsion wherein it depends on the probability of a phosphorus blob or particle being at a liquid/liquid/gas or liquid/solid/gas interface. Preferably, a volatile solvent with a boiling point lower than that of water is used to reduce the power needed to heat and preferably evaporate it. It is even possible to produce a significant phosphorus vapor pressure at temperatures below freezing if a solvent is used which has a boiling point below 0° C. It is also possible to obtain controllable vapors of phosphorus at higher temperatures than that of boiling water by choosing a solvent with a high boiling point. Moreover, it is also possible to have a greater phosphorus vapor contact area by using a volatile solvent and bubbling a gas directly into the solution or by flash evaporating the solvent by spray injection in a hot reactor, as will be described in more detail below.

The most basic ozone generation method in accordance with the invention includes the steps of obtaining a solution of yellow phosphorous in a solvent and exposing the solution to a source gas containing oxygen, for reaction of the oxygen with any phosphorous vapor released from the solution into the source gas to generate ozone.

The phosphorus vapor can be released from the solution by evaporating the solvent at the surface or by bubbling the source gas through the solution. The term source gas as used herein is intended to encompass pure oxygen gas, air, a flue gas, or any other gas containing oxygen in the gas phase.

The most basic ozone generator in accordance with the invention includes a container for holding a solution of yellow or white phosphorous, a source gas conveyor for contacting the solution with oxygen containing gas, and an ozone collector for capturing ozone gas generated by contact of the oxygen with phosphorous vapor associated with the solution.

In order to simplify the text, the term phosphorus used in the following is intended to encompass both white and yellow phosphorus and the term phosphorus solution used in the following is intended to encompass a solution of white or yellow phosphorus in any solvent in which the phosphorus is at least partly soluble.

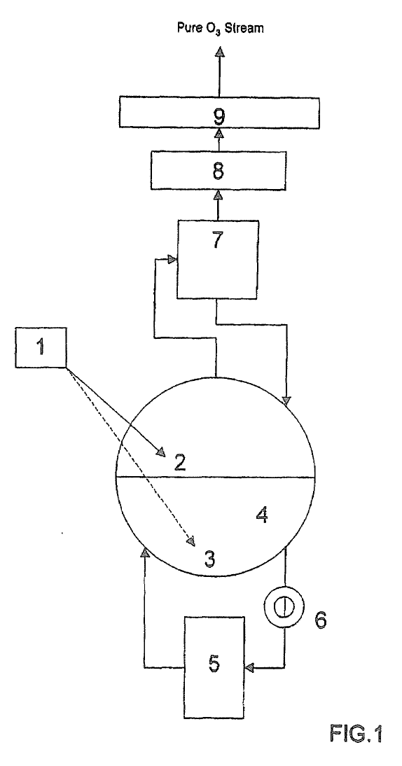

An exemplary embodiment of the ozone generation process of this invention is represented in FIG. 1. A flow of source gas, in this case air or oxygen from a pump (1), a compressor, an oxygen generator, oxygen tanks, or any other source of oxygen is passed over (2) or bubbled through (3) a phosphorus solution (4). The solvent used can be any solvent wherein white phosphorus is soluble or partially soluble. Chloroform is a preferred solvent because of its low boiling and melting points and its relative inertness, but it is also possible to use other solvents like, ethanol, ether, hexane, benzene, carbon disulfide, olive oil, oil of turpentine, oil of cloves, oil of mace, oil of aniseed, etc. In general, any solvent in which phosphorus is partially or totally soluble can be used. It is however preferable that the solubility of the white phosphorus in the solvent be as high as possible so that as much gaseous phosphorus as possible is released upon evaporation of the solvent. The rate of release of gaseous phosphorus from the solution can be controlled by controlling the rate of evaporation of the solvent, which is controlled by the temperature of the solvent and/or the pressure of the ambient atmosphere above the solvent. A temperature slightly lower than the boiling point of the solvent is preferably used to avoid an uncontrolled phosphorus oxidation reaction. Evaporation of the solvent brings a significant concentration of phosphorus into the gas phase, and the phosphorus vapor in turn reacts with the oxygen molecules to create ozone and phosphorus oxides in the gas phase. Due to the possibility of localized high temperatures generated during the reaction, some phosphorus may be transformed to red phosphorus. Red phosphorus is insoluble in the solution and may be removed by circulating the solution through a filter (5) by a pump (6). This filtering of the solution will continuously remove particles or insoluble matter, such as solid byproducts of the reaction. The gaseous products of the reaction as well as the solvent are preferably passed through a condenser (7) for condensing and recirculation of the solvent to the solution. The ozone and phosphorus oxide fumes produced in the phosphorus/oxygen reaction are preferably passed through a bubbler/scrubber (8) where the phosphorus oxides are captured, preferably as phosphoric acid. The remaining scrubbed ozone gas is directed toward an exhaust port where a filter (9) can be used to absorb, adsorb or chemically capture any trace of solvent before release of the ozone gas from the ozone generator. Preferably, the sorption process is reversible in order to allow recycling of any trace of solvent vapors that might have been captured in the filter (9).

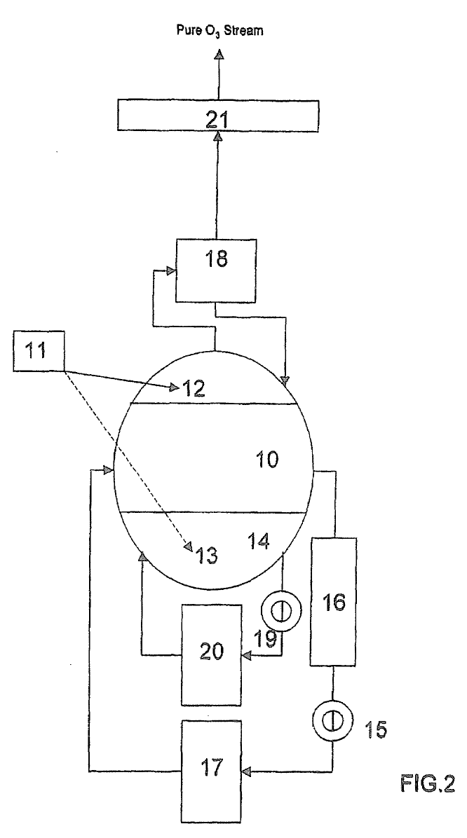

In the embodiment shown in FIG. 2, an insoluble aqueous solution (10) of hydrogen peroxide is used to capture the solid by-products of the reaction. This aqueous phase is less dense than chloroform and will float on top of the organic solvent. The role of the peroxide is to make soluble the solid that is usually forming during the reaction using the setup from the first preferred embodiment shown in FIG. 1. It was found that the solid by-product is not soluble in water, but can be oxidized by hydrogen peroxide or and absolutely not limited to any other oxidant such as potassium permanganate, potassium chromate, potassium iodide, etc soluble in water. It is desirable to use hydrogen peroxide since it is environmentally safe. However, this second liquid phase is not limited to aqueous solutions. Another non-miscible phase can also be used, it can even also be organic (i.e. alcohol, ether, etc) as long as it does not mix with the phosphorus solution. As with the previous embodiment, the source gas (11) is passed over the aqueous phase (12) or bubbled (13) into the solution of white phosphorus (14). In this case, the obvious advantage of bubbling in the organic phase is that the majority of the phosphorus oxides formed during the reaction to produce the ozone will react quickly with the aqueous phase to give a phosphoric acid solution. As well, any formation of red phosphorus will also be readily oxidized to phosphoric acid that is soluble in water. This will result in a cleaner ozone gas exiting the reactor to the condenser (7) and filter (9). The bubbler/scrubber (8) can be eliminated, since the aqueous solution can be adjusted through a loop attached to the reactor using a pump (15). This loop can also be cooled down with a heat exchanger (16) to help the condensation of the organic solvent phase. The aqueous solution is also filtered (17) and adjusted. The bubbles going through the phases will contain ozone and chloroform, as well as non-reacted oxygen and nitrogen (if air is the gas used). If the aqueous phase or a section of the phase is kept cool, the chloroform vapor will condense back directly in the reactor and reduce also the size of the condenser (18) usually needed to avoid losses through the exhaust port of the generator. The organic phosphorus solution is also pumped (19) through a filter (20) and its concentration is readjusted to maintain the reaction at optimum conditions. The cleaner ozone gas will be directed through a condenser (18) and a filter (21) to deliver a pure flow of ozone, free of organic solvent or contaminants.

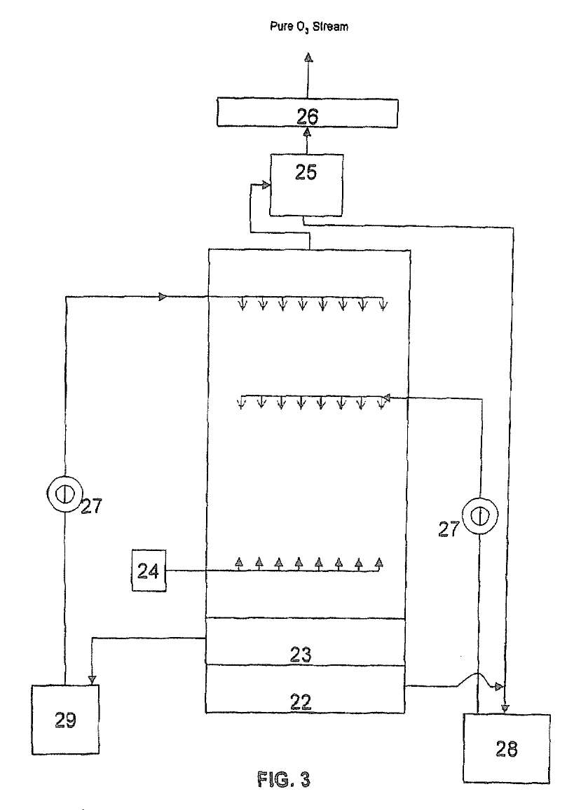

In case extremely high quantities of ozone are needed, the organic phosphorus solution (22), the peroxide solution (23) and the air/oxygen (24) can simultaneously be injected as a fine mist in a heated tower (FIG. 3). The top of the tower is equipped with a condenser (25) and filter (26) where the pure flow of ozone is directed. The resulting phases at the bottom of the tower can be recycled to the tower with pumps (27) or directed towards further treatment (28 &29).

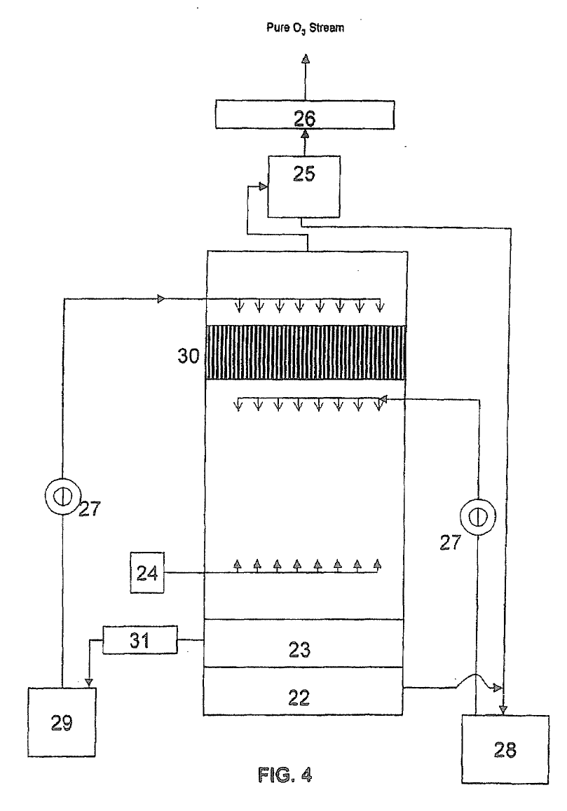

A variation of the previous embodiment is shown in FIG. 4. The top of the tower contains a built-in bubbler (30) where the gases are passed through the peroxide solution which is kept cool with a heat exchanger (31) to improve the phosphorus oxides and chloroform recovery. The condenser and filters can thus be scaled down accordingly.

The aforementioned preferred embodiments are those of ozone generators where a purified or non purified form of ozone is generated from the reaction of air/oxygen and a solution of white phosphorus. However, In-Situ formation and utilization of ozone from this reaction is also possible, and in some cases preferred. The phosphorus solution can be used directly with any form of waste or chemical process producing gaseous, liquid or solid phases or any mixture thereof. Although not necessary, it is preferable that the phosphorus solution not react with the waste or materials to be treated to take advantage of solvent recovery and recycling. It is also possible to add other species to the reactors in order to enhance the reaction or to engineer a reaction to specifically fabricate desired reaction products. Those added chemical species can also be gaseous, liquid and/or solid.

Many embodiments relating to the utilization of a phosphorus solution for the treatment of waste or for chemical reactions are possible and it is impossible to show them all in this disclosure. The following embodiments represent only a selection of those possibilities where a phosphorus solution can be used for the InSitu formation of ozone for oxidation purposes.

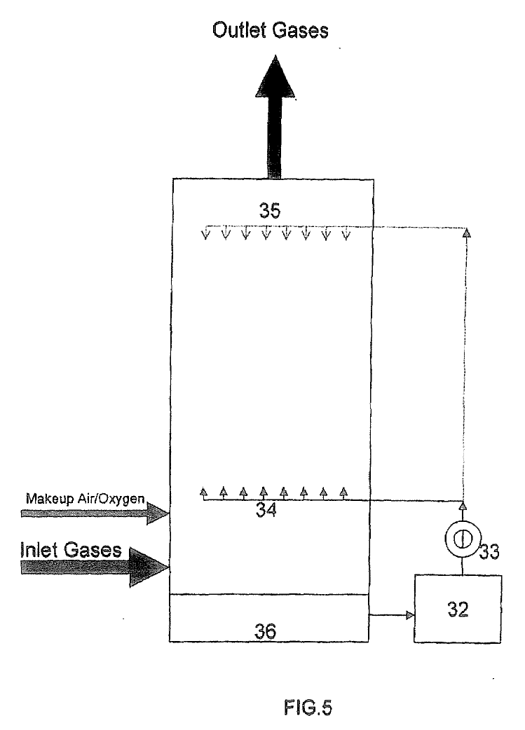

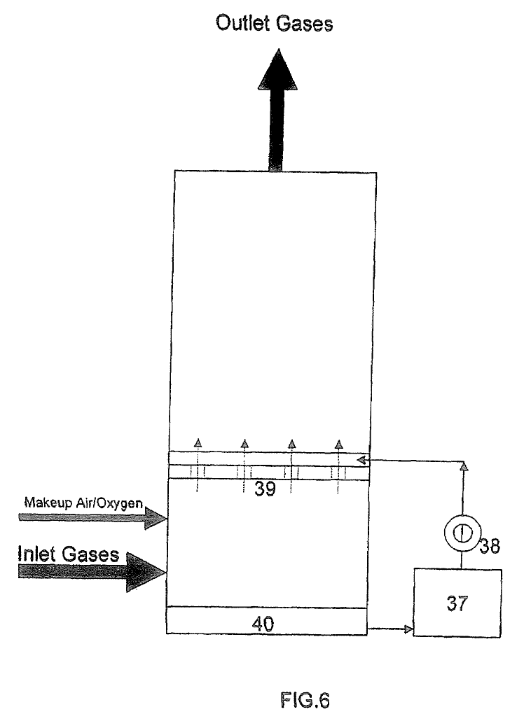

For the treatment or reaction of a gaseous species a process in accordance with FIG. 5, is used wherein the phosphorus solution (32) is injected using a pump (33) and sprayed as a fine mist using spray heads positioned at (34) or (35) and mixed with the gas in a horizontal or vertical tower type of reactor. It is also possible to spray the phosphorus solution ahead of the reactor into the inlet gases to be treated (not shown). For simplicity, only the vertical tower reactor is shown here. The gas mixture must contain oxygen in order to produce ozone and in order to be effective and it would be important to plan for makeup air or oxygen in any design. The gases in such reactor should preferably be at or above the boiling point of the injected solvent. In any case there is a possibility for condensation of the solvent and it can be collected at the bottom of the reactor (36) and recycled to the white phosphorus solution. It is also possible to bubble the gas through the white phosphorus solution (FIG. 6). The white phosphorus solution (37) is pumped (38) to a perforated section of the reactor (39) placed in the path of the gases to be treated. Of course in such process, the temperature of the gas should preferably be lower than the boiling point of the white phosphorus solvent. The solvent pooling at the bottom of the reactor (40) can also be recycled to the white phosphorus solution.

### EXAMPLE

| | Concentration |
|---|---|
| Flue Gas | |
| NO | 160 ppm |
| N2 | 90% |
| O2 | 10% |
| Water | 0.4 mg/cc |
| Flow | 400.65 cc/min |
| Injection Zone | |
| Temperature | 150 C. |
| Pressure | 1 atm |
| Residence Time | 3 s |
| WP Solution | |
| Solvent | Chloroform |
| WP concentration | 1 g/100 cc |

WP = white phosphorous

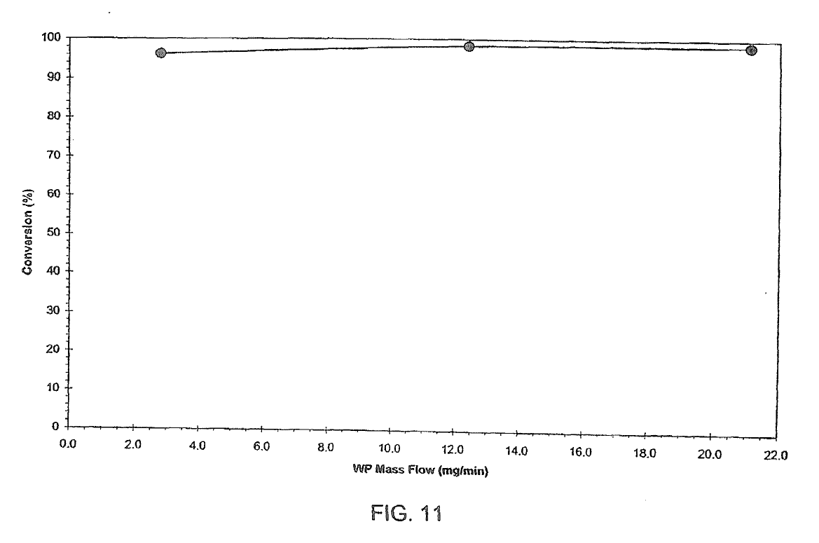

Simulated flue gas was generated by mixing the listed gases at the indicated concentrations using mass flow controllers. The final concentration of nitric oxide was 160 ppm with traces of nitrogen dioxide (NO2). The gas mixture was heated and loaded with water vapour at 95 C before being directed to the hot injection zone heated at 150 C. The setup corresponds to an arrangement similar to that of FIG. 5 where a white phosphorus (WP) solution is injected directly in the simulated flue gas. The white phosphorus solution was injected using a Masterflex™ metering pump. The white phosphorus solution was injected directly in the hot reaction zone gas phase using the tip of a Pasteur pipette coupled to the metering pump. The gases were then passed through a water cooled condenser to remove the water and chloroform before analysis. An additional water trap containing 100 cc of pure water was installed before the analyser in order to absorb any trace solvent or particulates in order to protect the analyser. The quantity of nitric oxide before and after reaction was monitored using a CAI 600 Series NOx analyser. As shown in FIG. 11, a NO conversion rate of >95% was consistently achieved in repetitive experiments with this experimental setup at different solution flow rates. A blank run using only the solvent showed a conversion of about 1%.

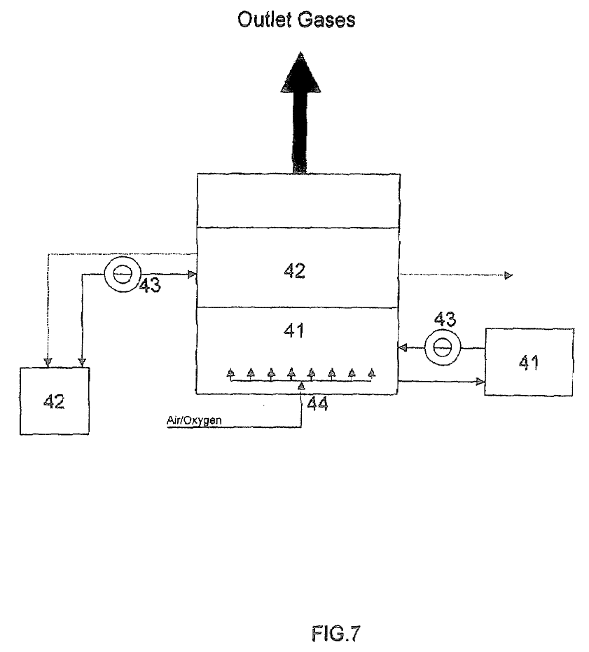

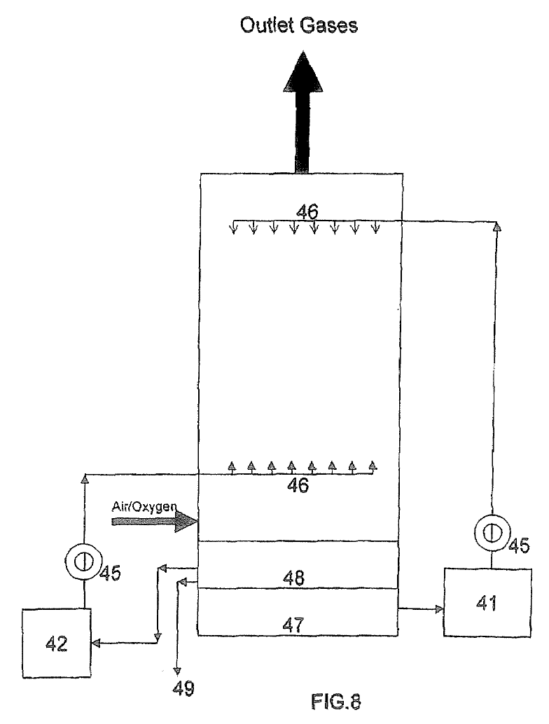

For the treatment of liquid waste (FIG. 7) or other chemical process dealing with liquids, the white phosphorus solution (41) can be added to the liquid (42) in a reactor using pumps (43). Air or oxygen is injected into the reactor (44) to produce the needed ozone for the oxidative reaction. The liquids may not need to be stirred mechanically since the injection of air may provide enough mixing. The white phosphorus solution (41) and the liquid to be oxidized (42) can also be simultaneously sprayed in a vertical or horizontal tower (FIG. 8) using pumps (45) and spray heads (46) while also injecting air or oxygen. In the case where the liquids are added to each other and in order for both liquids to remain liquid, the temperature of such reactor should be kept at a temperature lower than that of the lower boiling point. And, although preferable, the white phosphorus solution and the liquid to be treated should be immiscible or partly miscible in order to increase efficiency and decrease the risk of formation of undissolved white phosphorus but also to help in solvent recovery and recycling. The white phosphorus solvent found at the bottom of the reactor (47) can be redirected to the white phosphorus solution tank (41) and the liquid to be oxidized (48) also found at the bottom of the reactor can be either redirected for further oxidation in the reactor or removed for other purposes (49). In a setup where the liquids are sprayed inside a reaction chamber, the temperature of the reactor does not need to follow the restriction put by liquid mixtures.

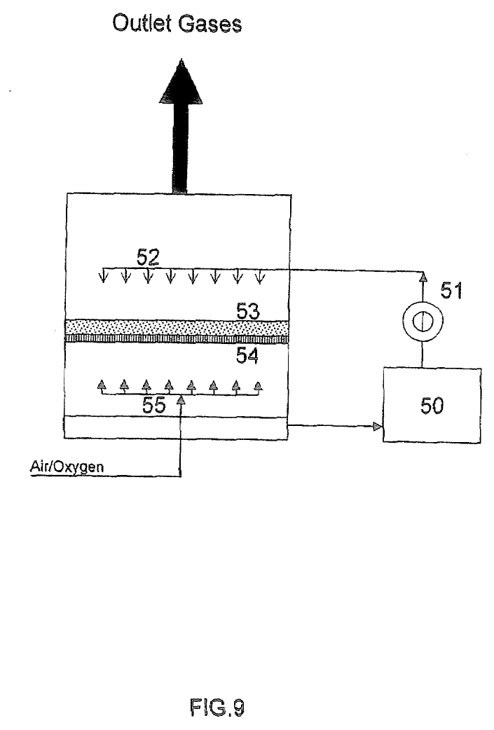

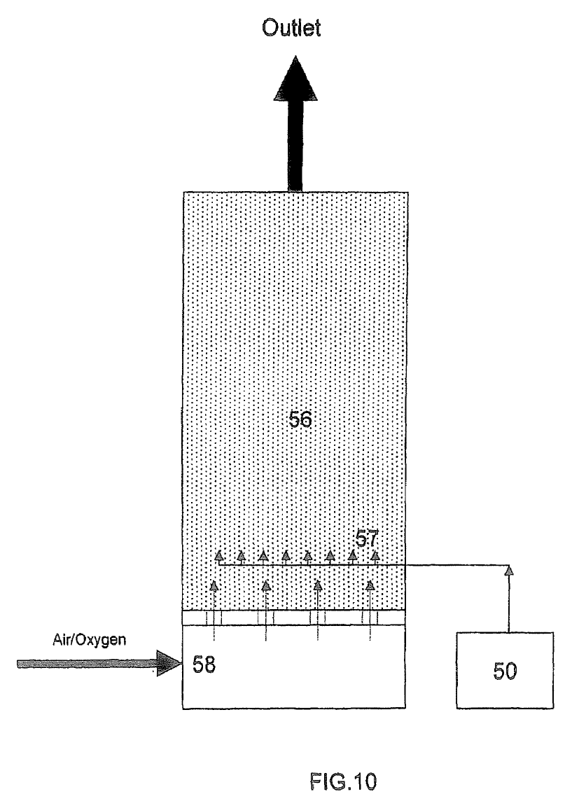

Treating solid waste or materials can also be done through different embodiments. In one such embodiment (FIG. 9), a white phosphorus solution (50) can be pumped (51) and sprayed (52) in a reaction chamber where the solid to be oxidized (53) is deposited on a perforated platen (54). Air or oxygen needs to be added (55) to the reactor in order to produce ozone. It is also conceivable for the solid to pass through such reaction chamber on a conveyor belt (not shown). The air or oxygen can be added at the same time or in a second step, the solid being soaked with the white phosphorus solution in a previous step and then heated with exposure to air or oxygen. The excess white phosphorus solvent can also be collected at the bottom of the reaction chamber and reused. In another embodiment (FIG. 10), the solid (56) can be fluidized in a reactor while the white phosphorus solution (50) is injected (57) and mixed. The solid is fluidized using air (58) which will react with the white phosphorus to produce ozone. It is also preferable to have such reactor at a temperature higher than that of the boiling point of the white phosphorus solvent.

Numerous other embodiments are also possible and are not limited to those mentioned above to deal with waste or reactors containing phase mixtures.

Many other embodiments are possible for those skilled in the art. The aforementioned embodiments are only a few examples representing the spirit of this patent.

Waste heat can also be used to maintain the reactors at the correct temperature in order to help the reaction and solvent capture systems will be needed down-flow for recycling through the process.

What is claimed is:

1. A method for producing ozone, comprising the steps of obtaining a phosphorus solution including white or yellow phosphorous dissolved in a solvent and contacting the phosphorus solution with a source gas containing oxygen, for reaction of the oxygen with phosphorous present in vapor form at a phosphorus solution/source gas interface.

2. The method of claim 1, wherein the step of contacting the phosphorus solution is carried out by passing the source gas over the solution.

3. The method of claim 1, wherein the step of contacting the phosphorus solution is carried out by passing the source gas through the solution.

4. The method of claim 1, wherein the step of contacting the phosphorus solution is carried out by distributing the phosphorus solution in the source gas.

5. The method of claim 4, wherein the distributing of the phosphorus solution is carried out by spraying the phosphorus solution into the source gas.

6. The method of any one of claim 1, wherein the rate of release of phosphorus vapor from the phosphorus solution is controlled by controlling at least one of the ambient pressure, the temperature of the solution and the temperature of the source gas.

7. The method of any one of claim 1, wherein the solvent is an organic or inorganic solvent in which the white or yellow phosphorus is at least partially soluble.

8. The method of claim 1, wherein the solvent is an organic or inorganic solvent in which the white or yellow phosphorus is fully soluble.

9. The method of claim 7, wherein the solvent is an organic solvent.

10. The method of claim 9, wherein the solvent is ethanol, ether, chloroform, hexane, benzene, carbon disulfide, olive oil, oil of turpentine, oil of cloves, oil of mace, or oil of anis seed.

11. The method of any one of claim 1, further comprising the step of capturing ozone gas generated upon reaction of the phosphorus vapor with the oxygen.

12. The method of claim 11, further comprising the step of purifying the ozone gas for removing phosphorus oxides.

13. A method of oxidizing a chemical compound, including the steps of producing ozone according to the method of any one of claim 1 and contacting the chemical compound with the ozone.

14. The method of claim 1, wherein the source gas is pure oxygen gas, air, a flue gas, or any other gas containing oxygen in the gaseous phase.

15. The method of claim 13, wherein the source gas is a flue gas and the chemical compound is nitric oxide gas contained in the flue gas.

16. The method of claim 15, wherein the solution is sprayed into the flue gas as a fine mist.

17. An ozone generator, comprising
a phosphorous solution supply;
a supply of a source gas containing oxygen; and
means for contacting the phosphorus solution with the source gas to produce ozone by reaction of the oxygen with phosphorus vapor present at a source gas/phosphorus solution interface.

18. The ozone generator of claim 17, wherein the means for contacting is a reaction chamber, the phosphorus solution supply is a container located in the reaction chamber and holding the phosphorus solution and the source gas supply is a conduit entering the reaction chamber for directing the source gas onto the phosphorus solution in the container.

19. The ozone generator of claim 17, wherein the means for contacting is a reaction chamber, the source gas supply is a flue gas conduit connected to the reaction chamber for directing an oxygen containing flue gas stream into the chamber, and the phosphorus solution supply is a spray arrangement for spraying the phosphorus solution into the flue gas stream in the reaction chamber.

20. A method for producing phosphorus vapor at a controlled rate, comprising the steps of generating a phosphorus solution by dissolving white or yellow phosphorus in a solvent in which the phosphorus is at least partially soluble, and controlling a rate of release of phosphorus vapor from the solvent.
